(19) United States
(12) Patent Application Publication
(10) Pub. No.: US 2026/0073372 A1
(43) Pub. Date: Mar. 12, 2026

(54) METHOD AND SYSTEM FOR AI-MODEL APPLICATION BIDDING FOR PROVIDING A RESPONSE TO A CLENT REQUEST

(71) Applicant: Supertab AG, Steinhausen (CH)

(72) Inventor: Cosmin-Gabriel Ene, Munich (DE)

(21) Appl. No.: 19/390,973

(22) Filed: Nov. 17, 2025

Related U.S. Application Data
(63) Continuation-in-part of application No. 18/430,051, filed on Feb. 1, 2024.

(30) Foreign Application Priority Data
Feb. 3, 2023 (IE) S2023/0020

(51) Int. Cl. G06Q 20/14; G06Q 30/0217; G06Q 30/08

(52) U.S. Cl. CPC G06Q 20/145; G06Q 30/0217; G06Q 30/08

(57) ABSTRACT

A computer-implemented method provides a response to a client request by receiving the request from a client device; determining a client identity issuing the request; transmitting information indicative of the request to a plurality of AI systems executing respective trained AI model applications; receiving from the AI systems, respective cost information for generating a response; transmitting a cost indication to the client device; processing an authorisation signal from the client device selecting a cost indication for generating a response; transmitting to the system associated with the selected cost indication, instructions to generate the response; receiving a generated response; transmitting the generated response to the client device; allocating the cost indication for the transmission of the response to client account based on the client identity; monitoring a total allocated amount to the client account; and request payment when the total allocated amount exceeds a predetermined threshold amount or period of time.

### CROSS-REFERENCE TO RELATED APPLICATIONS

This application is continuation-in-part of U.S. patent application Ser. No. 18/430,051, filed Feb. 1, 2024, which is based on and claims priority from Irish Patent Application No. S2023/0020 filed on Feb. 3, 2023.

### FIELD OF THE INVENTION

The invention relates generally to a method for providing a response to a client request, and specifically to such method that enables selection of one of a plurality of network-accessible systems executing respective artificial-intelligent (“AI”) model applications using a bidding process.

### BACKGROUND OF THE INVENTION

Systems for providing online chat conversations are known. In the recent years, it has been becoming increasingly popular to have chatbots or chatter bots which participate in chats conducted between human beings. In the recent years, there has been a development in the service sector to use chatbots for responding to customer requests, e.g., to answer simple questions about pricing, service conditions and so forth. The respective chatbots serve to reduce the workload on human service persons and filter out the most basic questions so that the human beings can respond to more complicated and sophisticated questions.

With the increasing progress that has been made with trained models like neural networks and others, the capability of so-called chatbots to respond to more complex questions increased. In November 2022, Open AI launched Chat Generative Pre-Trained Transformer, also known as ChatGPT. ChatGPT provides a chatbot that uses an autoregressive language model generated by deep learning to produce humanlike text. With the respective software, the technology has shifted from the field of responding to predefined questions into an area where longer texts can be generated.

For providing sophisticated answers and generating text, applications like ChatGPT require massive calculation power and therefore consume an excessive amount of energy. Therefore, there is an increasing need to provide economically sensible approaches to coordinate the use of such systems.

There are approaches available to monetarize consumed calculation power including, for example, Microsoft Corporation's online pricing calculator, azure.microsoft.com/en-us/pricing/calculator/. However, these approaches do not provide incentives which lead to a load distribution, or comparison of fees charged between different network-accessible systems providing AI model application services for generating a response to a client request.

Accordingly, it is an objective of the present application to provide an improved method for providing the responses to client requests. In particular, the method should allow the usage of resources effectively, and enabling users to select which network-accessible systems providing AI model application services the user wishes to generate a response to a client request. Furthermore, an adequate usability should be ensured.

### SUMMARY OF THE INVENTION

The present invention solves the respective problem by a method [and system] for providing a response from an artificial intelligence model application to a client request by at least one processor executing the steps of:
a) Receiving a client request over an interface from a client device, which may be in the form, for example, of at least one of an image, text, audio, and video data;
b) Determining a client identity based on at least one of a client issuing the request and the client device;
c) Transmitting over a network information indicative of the request to a plurality of systems executing respective trained artificial intelligence model applications;
d) Receiving from the plurality of systems respective cost information for their generation of a response to the request;
e) Transmitting at least one cost indication to the client device based at least in part on the received cost from the plurality of systems;
f) Processing an authorisation signal received from the client device indicating acceptance of a selected cost indication for generating a response to the request by a corresponding one of the plurality of systems that provided the cost upon which the selected cost indication was based;
g) Transmitting to the corresponding one of the plurality of systems that provided the cost upon which the selected cost indication was based, instructions to generate the response;
h) Receiving a generated response from the corresponding one of the plurality of systems that provided the cost upon which the selected cost indication was based;
i) Transmitting the generated response to the client device;
j) Allocating an amount to be paid by the client based on the client identity for the transmission of the response to the client device, with or without concurrently requiring payment of the amount, wherein the amount is based at least in part on the selected cost indication;
k) Monitoring a total allocated amount associated with the client identity; and
l) Transmitting a payment request, wherein the payment request is for at least partially settling the total allocated amount associated with the client identity when the total allocated amount exceeds at least one of (i) a predetermined threshold amount, and (ii) a threshold period of time since the earliest first allocated amount that is part of the total allocated amount.

It is possible for the request from the client to comprise at least one of an image, a text and/or audio/video data. The received client request can be a client request from a user or another computing device, such as a computer or mobile device.

In one embodiment, the disclosed method and/or system may determine the cost in step c) based at least in part on a forecast calculation of at least one of estimated or required electrical power for the trained artificial intelligence model to determine at least one of (i) a response to the request, and (ii) a partial response to the client request.

In another embodiment, the disclosed method [and/or system] may be accessible via devices used for establishing an augmented reality. For example, questions can be generated interactively by pointing towards real life objects (e.g., “What is this?”) and answers can be augmented via the respective device. For example, respective glasses add text to the pointed-out object showing the answer as generated by the response. Also, the method or the corresponding system can be accessible through a virtual reality. For instance, the client request can be generated while being in a virtual reality and/or based on any interaction with the virtual reality. In one embodiment, existing virtual worlds can be enhanced by providing interaction with the trained model, e.g., by improved navigation “Take me to the oldest building in this world.” or generative actions “Please add a room which fits the era of Napoleon.”

In the disclosed embodiments, the determining of a client identity is necessary to link the allocated amounts to a particular user, e.g., a participant in a chat, and/or a client device. For the present invention it is not necessary to identify the person as long as there is some indicator that links to the respective person or her/his user device. Also, it is not necessary to receive much information from the particular user, e.g., via registration process. To identify the client device and/or the user, any type of hardware identification number can be used such as a MAC address (Media-Access-Control) and/or a processor identification number and/or a hard disk identification number and/or an IP address and/or other unique device numbers, such as the unique device identifier (UDID) of a smartphone. Also, modern communication protocols provide access to mechanisms which allow identifying users and/or client devices. Such mechanisms can also be used to arrive at a client identity. The client identity can be any type of number or character and must not necessarily be unique to a single device and/or a single user. Some methods which can be used to establish a client identity in accordance with the inventive concept are discussed in WO2021259608 A1, which is incorporated in its entirety by reference herein.

In accordance with one aspect of the invention, the generating of the response is linked to the allocation of an amount to be paid. In accordance with the invention, the amount does not need to be paid immediately. The debt is only noted and allows an immediate progressing of the process.

A payment will only be required if the summed-up amount reaches a certain threshold value and/or has not been paid for a longer time period, e.g., within a month or two weeks.

By combining the concept of micropayments and/or fractional payments with the technology of chat bots, a very efficient approach to generating responses is achieved. While the micropayments or fractional payments do not constitute a significant hurdle to use the provided service, it filters the amount of requests and allows reducing the load on the servers that implement the method.

In accordance with the invention a fractional payment can be defined as a payment wherein the amount to be paid is a fraction of the smallest physical unit available in an official currency, e.g., a quarter of a Euro Cent.

In one embodiment, the method step d) comprises the step of from at least one of the plurality of systems a first part of the response in addition to its respective cost for generating a response to the request and transmitting said first part of the response to the client device prior to the performance of step f), and wherein the step g) is performed for generating a second part of the response.

In one embodiment, the method may further comprise the steps of: m) issuing at least one invitation message offering a reward for feedback on the provided receiving a message from the client device; n) receiving a feedback message from the client device on the response as transmitted in step i), wherein the feedback message is transmitted to the corresponding one of the plurality of systems that provided the cost upon which the selected cost indication was based; and; o) reducing the allocated amount to be paid in response to receiving the feedback message. In such embodiment, the method may additionally comprise the step determining a quality index of the feedback message, wherein for a particular feedback message, the step o) is only performed if the quality index meets a pre-set criteria with respect to a predefined threshold value.

In another embodiment, the offering of a reward for the feedback is based on a static amount, e.g., 5 Cents, 10 Cents or 1 Euro.

In yet another embodiment, the offer can be dynamic, e.g., depending on how much the trained model would benefit from the feedback or how long and/or adequate the feedback is.

In a further embodiment, the offered reward can be linked to a number of questions that the user is willing to answer.

Similarly, the invitation message can describe the algorithm according to which the reward is calculated or provide a tangible value. Alternatively, the invitation message can simply state that there will be a reward, and the reward is calculated once the feedback is received. According to this, the allocated amount associated with the particular user and/or client device is reduced in response to receiving the feedback message. Again, the amount can be calculated at the time of the reduction, or a flat rate can be reduced.

Thereby the micropayment and/or fractional payment system generates an incentive to improve the trained model. Furthermore, the incentive can be designed such that feedback is collected with that data that is most needed to improve the trained model. Thereby, the feedback can be controlled.

In one embodiment, the method comprises determining a quality of the feedback message. The respective quality can be described by a quality index, e.g., a numeric value.

In another embodiment, it is decided depending on the quality of the feedback whether or not it will be used to train the existing trained model and to provide feedback thereto. In a further embodiment, the reward, namely the reduction of the allocated amount is only given if the feedback as provided through the feedback message meets a certain quality criteria, e.g., the quality index is above a predefined threshold value.

In a further embodiment, the authorisation signal of step f) is received from the client device and/or generated based on predefined selection criteria. It is possible for the predefined selection criteria to be based at least in part on a lowest cost of the received cost, a highest credit offer to be applied against the total allocated amount associated with the client identity, a preferred one of the plurality of systems if the received cost from that preferred one of the plurality of systems is within at least one of a fixed amount and within a fixed percentage above the lowest cost of the respective cost information received from the plurality of systems.

In still a further embodiment, the receiving from the plurality of systems respective cost information for their generation of a response to the request in step d) includes a second cost from at least one of the plurality of systems, wherein the second cost is for generating a response to the request at a later time.

In yet another embodiment, step d) is performed prior to step a) and wherein the receiving from the plurality of systems respective cost information for their generation of a response to the request in step d) comprises receiving at least one of a rate table, or a forecast application to determine cost information for at least one of the responses based at least in part on:
(a) an estimated electrical power consumption for determining the response;
(b) a required electrical power actually consumed in determining the response;
(c) an estimated electrical power consumption for at least partially determining the response; and
(d) a required electrical power actually consumed in at least partially determining the response.

In another embodiment, the client is one of a person, business entity or computer system executing a prompt application to generate the client request.

The respective usage provides similar effects and advantages as discussed above.

### BRIEF DESCRIPTION OF THE DRAWINGS

The invention will now be described in greater detail using several exemplary embodiments and making reference to the drawings, in which:

FIG. 1 shows a representative client device, chat system and payment system connected through the internet;

FIG. 2 shows several exemplary components of the payment system in accordance with FIG. 1;

FIG. 3 shows an exemplary data structure for the payment system in accordance with FIG. 2;

FIG. 4 shows an illustrative flow diagram of a method for providing a response to a client request;

FIG. 5 shows several representative components of the chat system as captioned in FIG. 1.

FIG. 6 depicts an exemplary flow diagram of a method for providing a response to a client request using a bidding process enabling selection of one of a plurality of network-accessible systems executing respective AI model applications.

In the following description, the same reference signs are used for the same and similarly acting parts.

### DETAILED DESCRIPTION

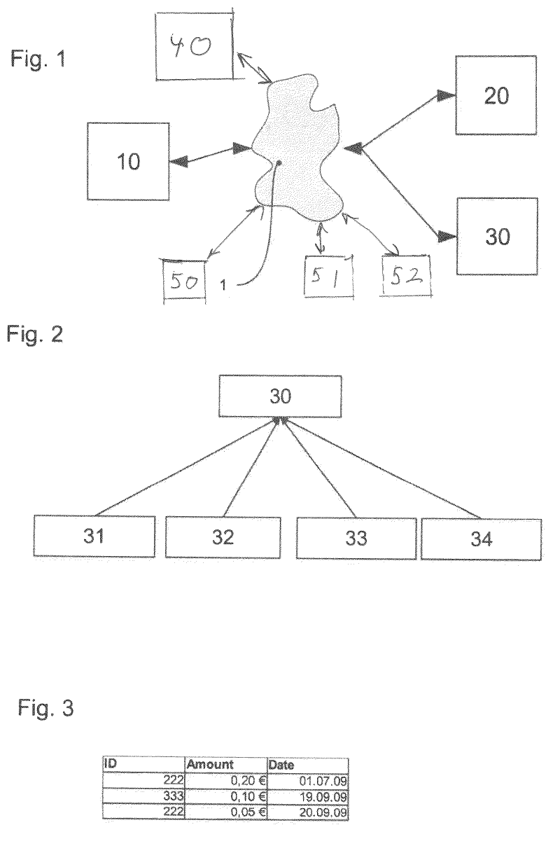

FIG. 1 shows a system according to the invention. A client device 10, for example, a laptop, a PC or a mobile terminal is connected via a network, in the present case the internet 1, to a chat system 20. The chat system 20 and the client device 10 are also in communicative connection, via the internet 1, with a payment system 30, preferably a payment system 30 to conduct micropayments.

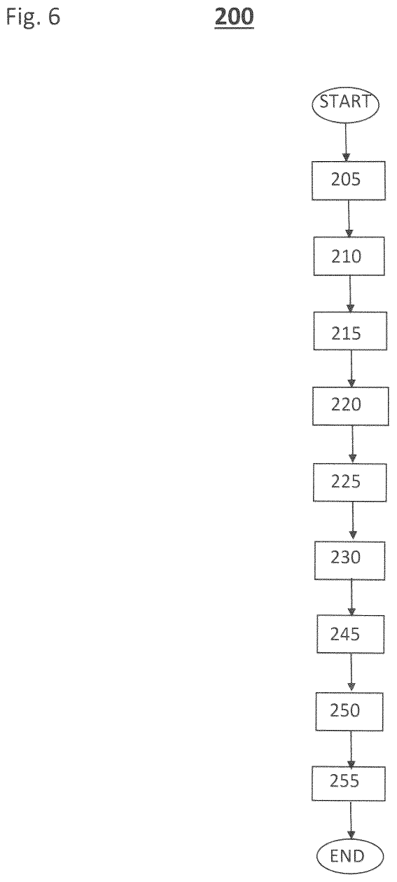

Normally, numerous other systems are connected to the internet 1, including, for example, a computer system 40 that is also capable of communicating with the client device 10 and payment system 30, and a plurality of AI computer systems 50, 51, and 52 (“AI systems”). Each of the AI systems 50, 51, and 52 are capable of executing respective trained AI model applications. Operation of the computer system 40 is described below with regard to FIG. 6.

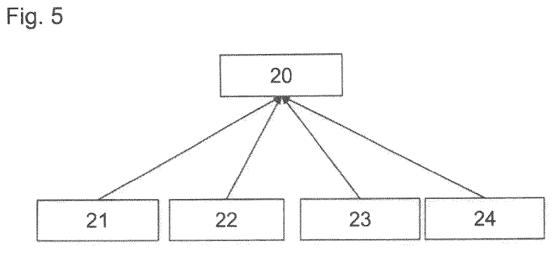

The chat system 20 can comprise a chat application 21 (FIG. 5) which can be a software program that allows users/participants to communicate with one another in real-time/near-time.

In one embodiment, the chat application 21 provides a customer service chatbot. The chatbot is designed to help customers with their queries or issues by providing automated responses. The chat system can be integrated with a company's website or mobile app, and used to handle customer queries, such as directing customers to the correct department for more complex issues.

In another embodiment the chatbot is designed in engaging in more sophisticated task, like helping to fill out customer forms or generating text for a damage report. Also, the chatbot can provide other services like generating sample code in a program language to solve a particular problem and/or generate individual letters for particular occasion which the user provides in a request to the chat application 21.

The chat application 21 can use a trained model 22 (FIG. 5) to generate the answers for a particular question provided by means of a request. In one embodiment, the trained model 22 is a large language model, e.g., a variant of the GPT (Generative Pre-trained Transformer) model. The training may be performed by a training application 23 which trains the model 22 on a massive amount of text data to generate human-like text. The chat application 21 can be adapted to be used for a wide range of natural language processing (NLP) tasks, such as text generation, language translation, and question answering.

In one embodiment, the chat application 21 is adapted to generate coherent and fluent text in a wide range of styles and formats. It can generate everything from creative writing to technical documentation and can even mimic different writing styles and voices.

In one embodiment, the chat application 21 is adapted to understand and respond to context. The trained model 22 is trained on a large amount of text data such that covers a wide range of topics and styles, which allows it to understand the context of a given input and generate appropriate responses. This makes it a powerful tool for tasks such as question answering and dialogue generation.

In one embodiment, the chat application 21 and particularly the trained model 22 is fine-tuned for specific tasks and industries by training it on a smaller, domain-specific dataset. This allows for more accurate and relevant responses for specific use cases. For example, fine-tuning trained model 22 on a dataset of customer service inquiries can improve its ability to understand and respond to customer queries.

In one embodiment, the chat application 21 uses other technologies, such as voice recognition and text-to-speech systems integrated, to create more advanced and interactive applications, such as voice assistants.

In one embodiment, the chat application 21 is its integration in GPT-3. GPT-3 is an even more advanced version of GPT-2, which includes 175 billion parameters. This allows the chat application 21 to perform a wide range of language tasks without any fine-tuning, including language translation, summarization, question answering, and text completion. The respective implementation allows the chat application 21 to be used for content creation.

The front end of the chat application 21 can take many different forms, depending on the application and the platform it is being used on. In one embodiment, it is a web-based interface that allows users to input text into a text box and receive output in a separate text area.

Alternatively, the input can be gathered in a virtual reality or in an augmented reality environment. It can also be an app for a mobile device that allows users to input speech and receive output in the form of synthesized speech. Similarly, the response can be made available in virtual reality or in an augmented reality environment.

In one embodiment, the front end of the chat application 21 includes a number of features and functions to improve the user experience. For example, it includes a history of previous interactions, allowing users to easily refer back to previous conversations. It can also include features such as text formatting and the ability to attach images or other files.

The front-end of the chat application 21 can be built using different software technologies such as HTML, CSS, and JavaScript. These technologies are used to create an interactive and responsive web-based interface.

In one embodiment, the trained model 21 is trained on a massive amount of text data, which means that it has a large number of parameters. In one embodiment it might have around 100 billion parameters. It is obvious that the larger the trained model 21 is, the more calculation power is necessary to process the input and generate a response.

In one embodiment, the chat system 20 comprises a forecast application 24 to estimate the calculation power necessary to respond to a particular request.

The complexity of the input and task is also an important factor in determining the necessary power required to at least partially answer the request. The forecast application 24 can uses measured values of the past to forecast the required calculation power for a new request. The length of the question and the type can be taken into consideration.

It is one aspect of the invention, that the chat system 20 uses the payment system 30 to receive a compensation for the provided answers.

The payment system 30 comprises an identification device 31, an interface device 32 to allow communication with the chat system 20 and/or the client device 10, a memory device 33 and a processing device 34. Payment system 30 is a digital payment platform that can allow users to purchase any type of digital goods and services in a flexible and convenient way. The payment system 30 may also enable users to pay for digital content, such as online articles, e-books, music, and video games, without the need to enter their credit card details every time they make a purchase.

In one embodiment, the payment system 30 works by allowing users to create a potentially anonymous account, e.g., without any payment information like a credit card number, and then pre-authorize/allocates certain amounts of money, which can then be used to make purchases. This pre-authorized/allocated amount can be settled—at a later stage—with a credit card or other payment method. Thereby the payment system 30 significantly facilitates making small, incremental payments without having these amounts immediately debited to the preferred payment method.

In one embodiment, the payment system 30 is adapted to make purchases on any website that has integrated with the payment system 30. The authorization can be given by clicking on a “Put it on my tab” button or link, which will allocate the amount to be paid. Several embodiments of a usable payment system 30 are discussed EP 2476087B1 which is incorporated in its entirety by reference herein.

The payment system can be a digital payment platform that allows users to purchase digital goods and services in a flexible and convenient way, without the need of entering credit card details every time. It may allow users to pre-authorize a certain amount of money, which can then be used to make purchases and try out digital goods and services before committing to a purchase. The payment system may also provide a variety of tools for merchants to integrate the platform into their e-commerce systems.

FIG. 2 shows individual components of the payment system 30. The payment system 30 according to one embodiment of the invention has an identification device 31 for recording at least one identification number of the client device 10 or the user, an interface device 32 for receiving and confirming direct debit orders from the chat system 20 or any other merchant system, wherein the debit orders comprise information relating to an amount to be paid to the chat system 20 or any other system, a memory device 33 for storing the allocated amounts in conjunction with the associated identification numbers ID and a processing device 34 for processing the incoming requests.

In one embodiment, the payment system 30 is adapted to identify the user device 10 based purely on the MAC address. The memory device 33 thus stores the amount to be paid in conjunction with the corresponding MAC address. For this purpose, the payment system 30 comprises a corresponding database in which corresponding tables are kept. An exemplary extract from a table kept therein is shown in FIG. 3. Said table comprises, for example, three columns, specifically a first column which contains the identification of a client device 10 or a user, a second column which contains the amount to be debited and a third column which contains the date on which the direct debit order was received by the payment system 30. Each line of the table in FIG. 3 corresponds to a direct debit order. Thus, it is possible to read from the table in FIG. 3 that on 1 Jul. 2009, 20 Eurocents were debited/allocated for identification number 222. Furthermore, on 20 Sep. 2009, 5 Eurocents were debited for the same MAC address.

The processing device 34 can use these entries to determine the total payable from the debit amounts (allocated amount) for particular identification numbers ID. For example, the total payable for identification number 222 comes to 25 Eurocents.

Thus, the payment system 30 can be configured, for example, so that a particular user has to settle his debts when they are greater than 0.29 Euro or 1 Euro or 10 Euro.

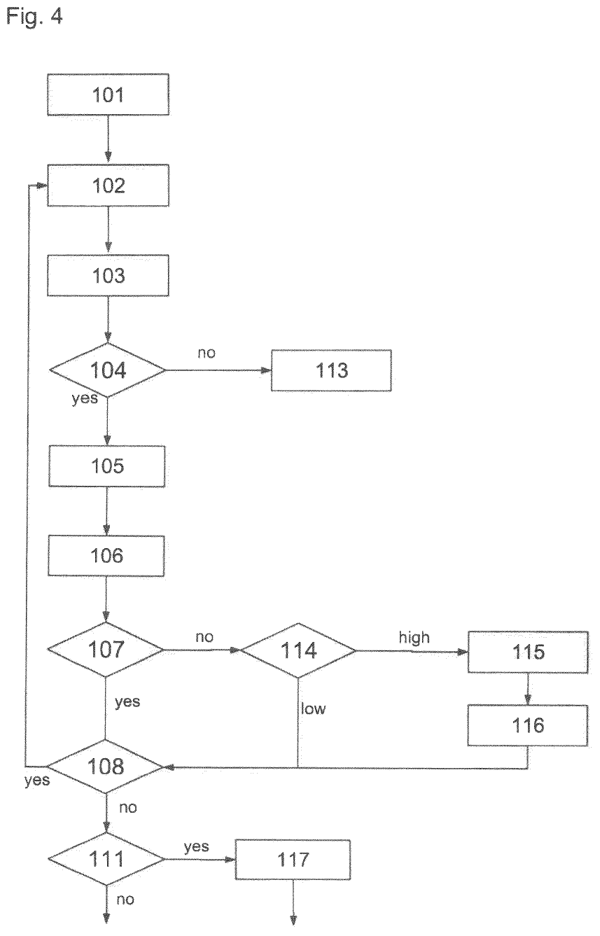

FIG. 4 describes one embodiment of an inventive process showing the interaction between the chat system 20 and the payment system 30. In Step 101 the identity of the user or participant in the chat application is determined. The respective determination process can be undertaken by the identification device 31 of the payment system 30 as previously described or by the chat system 20, e.g., the chat application 21. If the identification takes place on the side of the chat system 20, the respective identity or any other identity derived therefrom needs to be passed on to the payment system 30 for a later allocation of amounts with a particular user/participant.

In Step 102 the chat system, more precisely the chat application 21, receives a request from a user. Such a request could be to write an essay of 1500 words regarding the discovery of America.

In one embodiment, the forecast application 24 estimates the cost for responding to the request, e.g., by taking into consideration similar requests for writing an essay with that amount of words that have been answered previously. For doing so, the chat system 20 can log calculation power in relation to requests.

Alternatively or additionally, requests can be linked to certain amounts of energy consumption or other physical parameters required for performing the respective calculation. In one embodiment, the estimated costs are output to the user and the user is asked whether he is willing to bear the respective costs (Step 103). In Step 104 a response from the user is collected and it is determined whether the user authorizes the payment, e.g., by an authorization message. In Step 105, the chat system 20 may engage with the payment system 30, pass on the collected identity of the user and the costs for determining a response to the initial request. At that stage, the payment system 30 may allocate the respective amount of money for the particular user without requiring any immediate money transfer as previously discussed. In a not shown feedback step, the payment system 30 may confirm to the chat system 20 that the respective amount has been allocated. Under the condition that the payment system 30 confirms the respective transaction, the chat application 21 may output the response to the request in Step 106. For example, the complete essay containing around 1500 words may be transferred to the user.

In Step 107, the chat system 20 or the chat application 21 may invite the user to provide feedback on the received response. In one embodiment, such feedback might just comprise a statement whether the response was satisfying or not. Alternatively, the response can be graded from very good to very poor, e.g., with different numeric values. In a (preferred) embodiment the user is enabled to provide feedback in a written form, e.g., “The essay is great, but you need to check your facts. Columbus arrived in America in 1492.” In such a situation the feedback from the user might be checked by the chat system in Step 114. Assuming that the quality of the feedback is high, the trained model 22, which has been used to generate the respective response, can be trained with the feedback (Step 115). The respective training can be performed online or offline.

In one embodiment, the feedback comprises a reference, e.g., an URI or URL, pointing to a resource verifying the correctness of the feedback.

If the quality of the feedback is high and was used for training or is intended to be used for training, the user can be offered a reward. Such a reward can be that the sum of allocated amounts stored by the payment system 30 will be reduced by a certain amount. For doing so, the chat system 20 once again interacts with the payment system 30, e.g., over the interface device 32, and informs the payment system about the identity of the user as well as the amount to be credited. In one embodiment, a credit can be assigned to the account that is linked to the identity.

If the user indicates in step 104 that he is not willing to pay for a response to the client request, the response might be denied in step 113. Alternatively, the user might be invited to compensate for the response by a different means, e.g., by watching a commercial and/or providing personal details and/or responding to a certain amount of questions.

In one embodiment, step 104 either encounters about the user's willingness to pay for the request and/or his willingness to watch a commercial and/or to perform any other action for compensation.

In one embodiment, the costs are calculated based on the amount of references necessary to determine the response and/or the amount of compensation that has to be paid to other users for using references (content/resources).

In the respective embodiment, the chat system 20, in particular the training application 23 might keep track of the resources that have been used for training the trained model 22. The system might offer a compensation for each of the references that have been used for the training. It is possible to statically compensate the respective references/reference providers, e.g., by providing these with microcredits/micropayments. The respective credit might simply depend on how much information the respective resource has provided.

In another embodiment, the compensation might be determined dynamically, e.g., by keeping track of the resources that have been used to generate a particular response. Again, the respective resources/resource provider can be rewarded with a fixed amount and/or with a dynamic amount that depends on the amount of information that was derived from the particular resource for the particular response.

In one embodiment, where the trained model 22 is a generative model using text blocks, each of the text blocks can be linked to one or several resources. Assuming that the respective text block is used for a response, the correlating resource can be compensated. With other generative (pre-trained) transformer models identifying the resources that triggered a particular response, might be significantly more difficult. Still, it is possible to make respective assessments and to assign proper compensation.

In the above discussed embodiments, compensation payments might be based on the user's willingness to pay for the use of the system. In another embodiment, the respective relationship might not exist. Again, a payment as discussed with regards to the payment system 30 might be used to provide the compensation to the particular resources.

In one embodiment, the authors of the respective resources might not be identifiable at the time of compensation and/or training. Thus, the system provides in one embodiment the option of claiming the compensation that has been anonymously accumulated for a particular resource. Claiming the respective compensation might involve providing proof that the content of the respective resource has been produced by the particular party (content provider) claiming the compensation.

Alternatively, if in Step 114 the quality of the feedback is assessed to be low, no reward might be offered. Instead, the user might be immediately taken into a dialog or scenario in which he can decide whether or not further requests are to be issued to the chat application 21. If so, the process will start again with Step 102, in which the chat application 21 receives another request.

In one embodiment, after finishing Step 108—no further questions—might be requested by the payment system to settle the allocated amounts, e.g., in Step 105, through a payment. In an alternative embodiment, as shown in FIG. 4, the payment system 30 will check whether the allocated amount exceeds a threshold value. If this is the case, the payment system 30 would invite the user to settle the allocated amounts. Otherwise, the user would be free to continue, e.g., by consuming other digital content or by returning to the chat system 20 at a later stage.

In one embodiment, the step 104 may comprise the option of receiving a day pass or any other pass that is limited by a certain amount of questions/client requests and/or a certain amount of time for which the system can be used. In one embodiment, responses are generated in an iterative process whereby the user gets to specify an initial question more precisely and/or amend the initial question. The cost estimate might cover several iterative cycles in which the question will be further defined or amended.

In another embodiment no cost estimates might take place in Step 104. The user could be invited to agree to the allocation of a certain amount after having received the response (after Step 106). The allocated amount can be based on a true measured consumption value (calculated and/or consumed electrical power) or on a fixed value. In yet another embodiment, the response might be delivered partially prior to allocating any amount for the response (Step 105). The second part might only be delivered once the allocation has taken place and/or the user has agreed to such an allocation.

Furthermore, in any of the above-described embodiments, the check in accordance with Step 111 with or without the Step 117 might be performed at a much earlier point in time, e.g., immediately after Step 104. Thus, the “credit worthiness” (of the user) would be checked whenever the user indicates that he would be willing to pay for the respective response. In a situation in which the already allocated amount exceeds the threshold or meets other criteria for an immediate payment, the process could be interrupted until the user settles the allocated amount, e.g., in Step 117.

Also, the inventive method might be implemented without the Step 107 and the following Steps 114, 115 and 116.

In the above captioned embodiments, there is a physical separation between the chat system 20 and the payment system 30. However, the invention can also be implemented without said physical separation. All necessary software components can be run on a single hardware. Also, in the above description different software components are named separately, e.g., the chat application 21, the training application 23, the forecast application 24. However, as part of the invention all of these components together with the necessary components for implementing the payment system 30 can be a single piece of software or separate in different software components depending on the implementation preference and/or other requirements imposed when implementing the respective systems 20, 30.

In accordance with the invention, an automated quality check of digital content can be implemented using a combination of natural language processing (NLP), techniques and machine learning (ML) algorithms. One possible approach would be to use NLP to extract features from the digital content, such as grammar, spelling, and readability. These features can then be fed into a ML model, such as a decision tree or a neural network, that has been trained on a dataset of high-quality and low-quality content. The model can then predict the quality of new content based on the features it extracts. Another approach would be to use pre-trained Language model such as GPT-3 to check the coherence, fluency, and structure of the digital content. Also, previous response and/or questions, the course of a chat communication can be taken into consideration.

In one embodiment, an automated quality check of digital content (Step 114) would be to cross-check the content at least partially against an existing database, such as Wikipedia, to ensure that the information provided is accurate and reliable. In one embodiment, this could be done again using NLP techniques to extract key entities and concepts from the digital content provided (feedback), and then comparing them to the corresponding entries in the database.

For example, the system could identify named entities, such as people, places, dates and organizations, and then check if they exist in Wikipedia, potentially in the same context as used in the chat conversation. It could also extract key concepts and check if they are correctly defined and used in context. If the system finds any discrepancies or errors, it could flag the content as potentially low-quality.

Additionally, the system could use sentiment analysis to check the tone and sentiment of the content, to ensure that it is appropriate and not offensive or biased.

Finally, the system could be designed to be adaptive and improve over time by continuously learning from the feedback provided by human editors who evaluate the feedback.

The payment system 30 might be adapted to handle payments of fiat and/or virtual currencies. The payments might be micropayments and/or fractional payments.

Furthermore, as already discussed above, step 117 might offer alternatives to a true payment (in a virtual or fiat currency), e.g., the user can be requested to perform certain actions as already discussed above to compensate for the allocated amount.

FIG. 6 depicts a method 200 that is an alternative embodiment for providing a response to a client request by utilizing the computer system 40 and the plurality of network-accessible computer systems executing AI model applications, such as for example, AI systems 50, 51, and 52 in FIG. 1, whereby the computer system 40 would communicate the client request to the respective AI systems 50, 51, and 52 to obtain their cost information to generate a response and effectively, bid for generating the response.

Referring to FIG. 6, the method 200 begins with step 205 where the computer system 40 receives the client request from the client device 10. The client request may be in the form of, for example, at least one of an image, text, audio and video data. The client device 10 may be associated with a client that is one of a person, business entity or computer system executing a prompt application to generate the client request. A client identity based on a client issuing the request and the client device 10 is determined in step 210. In step 215, the computer system 40 transmits over the network 1 information indicative of the request to the plurality of AI systems 50, 51, and 52, executing respective trained AI model applications. The method 200 is described with regard to three AI systems for ease of illustration, it should be understood that it is possible for the computer system 40 to send the information indicative of the request to a smaller or larger number of systems executing trained AI model applications in accordance with this disclosure.

In step 220, coast information for generating a response to the request are received by the computer system 40 from respective ones of the plurality of AI systems 50, 51, and 52. It should be understood that such receipt of respective cost information by the computer system 40 may be from a subset of the AI systems 50, 51, and 52, to the extent that any of such systems is unable or unwilling to generate its cost information and/or a response to the request. Further, the AI systems 50, 51, and 52 may transmit a credit offer in addition to their associated cost for generation a response to the client request.

In step 225, the computer system 40 transmits at least one cost indication to the client device based at least in part on the received cost information from the AI systems 50, 51, and 52. Each cost indication can be a sum comprising the cost information received from respective one of the AI systems 50, 51, and 52, with or without markup or discount. The markup can be a fixed amount or percentage, or based on the differences between the cost information received from one or more of the AI systems 50, 51, and 52. In the alternative, the computer system 40 may transmit a smaller number of cost indications to the client device 10. Reasons for sending a smaller number of cost indications may include, for example, if a received cost is significantly higher those other received cost information for generating a response to the request, or if from an AI system whose prior responses were of low quality or accuracy.

Then, in step 230, the computer system 40 processes an authorisation signal received from the client device 10, wherein the authorisation signal indicates acceptance of a selected cost indication for generating a response to the request. In step 235, the computer system 40 transmits an instruction to generate the response, to the corresponding one of the AI systems 50, 51, and 52, that provided the cost information upon which the selected cost indication was based. In step 240, a corresponding generated response is received by the computer system 40, from the corresponding one of the plurality of AI systems 50, 51, and 52, that received the instruction. In step 245, the computer system 40 transmits the received generated response to the client device 10.

In step 250, the selected cost indication amount for the generated response to the client device is allocated to an account based on the client identity maintained, for example, in the payment system 30. Such allocation is made with or without concurrently requiring payment of the amount, wherein the amount is based at least in part on the selected cost indication. The payment system 30 monitors the total allocated amount in the account associated with the client identity in step 255, which can be performed intermittently, periodically, or prior to, in conjunction with, or after an amount is allocated to such account.

In step 260, the last step of the method 200, a payment request for at least partially settling the total allocated amount to the account associated with the client identity is transmitted to the client device 10 by the payment system 30 or the computer system 40, when or if the total allocated amount exceeds at least one of (i) a predetermined threshold amount, and (ii) a threshold period of time since the total allocated amount in the account last had no balance.

In an alternative embodiment of the method 200, the computer system 40 may receive from at least one of the AI systems 50, 51, and 52, in step 220, a first part of the response, such as brief high level summary, in addition to its respective cost for generating a full response to the request and transmits the first part of the response to the client device 10 prior to the performance of step 230, i.e., receipt and processing of the authorisation signal received from the client device, and in step 240, the computer system 40 receives a second part of the response the AI systems 50, 51, and 52, that provided the cost information upon which the selected cost indication was based.

In an alternative embodiment of the method 200, the computer system 40 may further perform the steps of: (i) issuing at least one invitation message offering a reward for feedback on the provided receiving a message from the client device 10; (ii) receiving a corresponding feedback message from the client device 10 based on the response as transmitted in step 240 (receipt of the generated response), wherein the feedback message is transmitted to the corresponding one of the plurality of AI systems 50, 51, and 52, that transmitted the generated response; and (iii) reducing the allocated amount to be paid in response to receiving the feedback message. Also, a variation of this alternative embodiment of the method 200, further includes the steps of determining a quality index of the feedback message, wherein for a particular feedback message, the step (iii) of reducing the allocated amount to be paid in response, is only performed if the quality index meets a pre-set criteria, such as for example, with respect to a predefined threshold value or by some other means.

In a further alternative embodiment of the method 200, the received and processing of the authorisation signal may be generated automatically by the client device 10 or the computing system 40. The predefined selection criteria may be advantageously based at least in part on a lowest cost of the received cost, a highest received credit offer to be applied against the total allocated amount associated with the client identity, a preferred one of the plurality of AI systems if the received cost from that preferred AI systems is within at least one of a fixed amount and within a fixed percentage, above the lowest cost of the respective cost information received from the plurality of AI systems.

In a modified embodiment of the method 200, the received cost information from the respective plurality of AI systems in step 220 includes a second cost from at least one of the plurality of systems, wherein the second cost is for generation of a response to the client request at a later time. In a further modified embodiment of the method 200, the step 220 is performed prior to step 205, wherein the receiving from the respective cost information from the plurality of AI systems in step 220 comprises receiving from a database (not shown) associated with the payment system 30, computer system 40, or any of the AI systems 50, 51, and 52, at least one of a rate table, or execution of a forecast application to determine the cost information based at least in part on (i) an estimated electrical power consumption for determining the response; (ii) a required electrical power actually consumed in determining the response; (iii) an estimated electrical power consumption for at least partially determining the response; and (iv) a required electrical power actually consumed in at least partially determining the response.

The method 200 and system of FIG. 1, have been described with regard to the payment system 30 and computer system 40 performing respective steps for ease of illustration. However, such payment system 30 and computer system 40 may be implemented in the same computer system or a larger number of computer systems. In addition, individual steps that were described as being performed by the payment system 30 may be performed by the computer system 40, or vice-versa.

At this point, it should be noted that all of the parts described above are claimed to be relevant to the invention when considered alone and in any combination, especially of the details shown in the drawings.

### REFERENCE SIGNS

1 Internet
10 client device
20 Chat system
21 Chat application
22 Trained model
23 Training application
24 Forecast application
30 Payment system
31 Identification device
32 Interface device
33 Memory device
34 Processing device
40 Computer system
50 first AI system executing an AI model application
51 second AI system executing an AI model application
52 third AI system executing an AI model application
ID Identification number
101 Step 101: Determine identity of participant
102 Step 102: Receiving request
103 Step 103: Estimating costs for responding to the request
104 Step 104: Is participant willing to pay for the request
105 Step 105: Allocating an amount for the response
106 Step 106: Generating and outputting a response
107 Step 107: Is the participant satisfied with the response
108 Step 108: Further questions?
111 Step 111: allocated amount exceeding threshold?
113 Step 113: Deny response
114 Step 114: Check quality of the feedback
115 Step 115: Train model with feedback
116 Step 116: Reduce allocated amount
117 Step 117: Initiating payment
200 Method for response from an AI model application to a client request using a bidding process
205 Step 205: Receiving a client request
210 Step 210: Determining identity of client
215 Step 215: Transmitting the client request for obtaining cost for generating a response to the client request
220 Step 220: Receiving the cost information for generating a response to the client request
225 Step 225: Transmitting cost indication(s) to the client device
230 Step 230: Processing an authorisation signal received from the client device
235 Step 235: Transmitting instructions to one of the plurality of systems to generate response
240 Step 240: Receiving a generated response to the client request
245 Step 245: Transmitting the generated response to the client device
250 Step 250: Allocating amount for the response
255 Step 255: Monitoring a total allocated amount associated with the client identity
260 Step 260: transmitting payment request

1. A computer-implemented method for providing a response from an artificial intelligence model application to a client request comprising the steps of:
a) Receiving a client request over an interface from a client device;
b) Determining a client identity based on at least one of a client issuing the request and the client device;
c) Transmitting over a network information indicative of the request to a plurality of AI systems executing respective trained artificial intelligence model applications;
d) Receiving from the plurality of AI systems respective cost information for their generation of a response to the request;
e) Transmitting at least one cost indication to the client device based at least in part on the received cost from the plurality of AI systems;
f) Processing an authorisation signal received from the client device indicating acceptance of a selected cost indication for generating a response to the request by a corresponding one of the plurality of AI systems that provided the cost upon which the selected cost indication was based;
g) Transmitting to the corresponding one of the plurality of AI systems that provided the cost upon which the selected cost indication was based, instructions to generate the response;
h) Receiving a generated response from the corresponding one of the plurality of AI systems that provided the cost upon which the selected cost indication was based;
i) Transmitting the generated response to the client device;
j) Allocating an amount to be paid by the client based on the client identity for the transmission of the response to the client device, with or without concurrently requiring payment of the amount, wherein the amount is based at least in part on the selected cost indication;
k) Monitoring a total allocated amount associated with the client identity; and
l) Transmitting a payment request, wherein the payment request is for at least partially settling the total allocated amount associated with the client identity when the total allocated amount exceeds at least one of (i) a predetermined threshold amount, and (ii) a threshold period of time since the earliest first allocated amount that is part of the total allocated amount.

2. The method of claim 1, wherein the client request is in the form of at least one of an image, text, audio and video data.

3. The method of claim 1, wherein step d) comprises the step of:
receiving from at least one of the plurality of AI systems a first part of the response in addition to its respective cost for generating a response to the request, and transmitting said first part of the response to the client device prior to the performance of step f), and
wherein the step h) is performed for receiving a second part of the response.

4. The method of claim 1, further comprising the steps of:
m) issuing at least one invitation message offering a reward for feedback on the provided receiving a message from the client device,
n) receiving a feedback message from the client device on the response as transmitted in step i), wherein the feedback message is transmitted to the corresponding one of the plurality of AI systems that provided the cost upon which the selected cost indication was based; and
o) reducing the allocated amount to be paid in response to receiving the feedback message.

5. The method of claim 4, further comprising the step of determining a quality index of the feedback message, wherein for a particular feedback message, the step o) is only performed if the quality index meets a pre-set criteria with respect to a predefined threshold value.

6. The method of claim 1, wherein the authorisation signal of step f) is received from the client device.

7. The method of claim 1, wherein the authorisation signal of step f) is generated based on predefined selection criteria.

8. The method of claim 7, wherein the predefined selection criteria is based at least in part on a lowest cost of the received cost, a highest credit offer to be applied against the total allocated amount associated with the client identity, a preferred one of the plurality of AI systems if the received cost from that preferred one of the plurality of AI systems is within at least one of a fixed amount and within a fixed percentage above the lowest cost of the respective cost information received from the plurality of AI systems.

9. The method of claim 1, wherein the receiving from the plurality of AI systems respective cost information for their generation of a response to the request in step d) includes a second cost from at least one of the plurality of AI systems, wherein said second cost is for generating a response to the request at a later time.

10. The method of claim 1, wherein step d) is performed prior to step a) and wherein the receiving from the plurality of AI systems respective cost information for their generation of a response to the request in step d) comprises receiving at least one of a rate table, or a forecast application to determine the cost information for at least one of the response based at least in part on:
(a) an estimated electrical power consumption for determining the response;
(b) a required electrical power actually consumed in determining the response;
(c) an estimated electrical power consumption for at least partially determining the response; and
(d) a required electrical power actually consumed in at least partially determining the response.

11. The method of claim 1, wherein the client is one of a person, business entity or computer system executing a prompt application to generate the client request.
